(19) United States
(12) Patent Application Publication
(10) Pub. No.: US 2022/0400807 A1
(43) Pub. Date: Dec. 22, 2022

(54) Footwear Upper

(71) Applicant: W. L. GORE & ASSOCIATES GMBH, Putzbrunn (DE)

(72) Inventors: Ambrosius BAUER, Warngau (DE); Martin PFISTER, Hoehenkirchen (DE); Kerstin SCHILLER, Putzbrunn (DE)

(21) Appl. No.: 17/765,538

(22) PCT Filed: Oct. 13, 2020
(86) PCT No.: PCT/EP2020/078808

§ 371 Date: Mar. 31, 2022

(30) Foreign Application Priority Data
Oct. 14, 2019 (EP) PCT/EP2019/077787

(51) Int. Cl. A43B 1/028; B32B 7/022; B32B 27/08; B32B 27/16; B32B 27/12; B32B 5/02; B32B 5/26; B32B 27/34; B32B 27/40; B32B 27/32

(52) U.S. Cl. CPC A43B 1/028; B32B 7/022; B32B 27/08; B32B 27/16; B32B 27/12; B32B 5/022; B32B 5/265; B32B 27/34; B32B 27/40; B32B 27/322; B32B 2250/02; B32B 2250/04; B32B 2250/24; B32B 2255/02; B32B 2255/26; B32B 2262/0292; B32B 2262/0261; B32B 2307/732; B32B 2307/7246; B32B 2307/718; B32B 2307/3065; B32B 2307/73; B32B 2437/02

(57) ABSTRACT

Textile composites for garments including footwear uppers and footwear comprising the same that provide protection from flame and liquid water whilst at the same time being lightweight and flexible for the wearer. The textile composite comprises a microfiber outer layer; a nonwoven layer, and in some embodiments a porous polymeric membrane on a support layer.

### CROSS-REFERENCE TO RELATED APPLICATION

This application is a national phase application of PCT Application No. PCT/EP2020/078808, internationally filed on Oct. 13, 2020, which is a continuation of PCT Application No. PCT/EP2019/077787, internationally filed on Oct. 14, 2019, which are herein incorporated by reference in their entireties for all purposes.

### FIELD

The present disclosure relates to textile composites and footwear uppers comprising the textile composites, specifically to footwear uppers to be used in footwear that are required to provide protection for the user from extreme heat, flame, liquids, particles and abrasion, as well as garments comprising textile composites as outer materials.

### BACKGROUND

Protective composites, for example textile composites, footwear uppers, footwear and garments comprising the textile composites are often worn for protection from a hazardous environment, and more particularly, to such footwear worn by firefighters for protection from extreme heat, flame, liquids, particles and abrasion.

Protective footwear is designed to shield a wearer from a variety of environmental hazards, and firefighter footwear is representative of such protective footwear.

Protective footwear often worn by firefighters typically comprises a leather upper that is heavy and thick to ensure that the footwear upper provides the sufficient level of protection required. The weight and thickness of the leather upper of such protective footwear can result in footwear being heavy, inflexible and uncomfortable for the user. Furthermore, during use, the leather upper can take on or absorb water, thereby increasing the weight of the footwear and correspondingly further increasing the strain and effort required by the user to work wearing the wet heavier footwear. After use, the wet footwear typically require a long drying time to return the footwear to the original condition, resulting in an extended period that the footwear is not available for use.

Furthermore, during use, the leather upper allow particles, such as those in smoke, to penetrate into the interior of the footwear and expose the wearer to potentially hazardous particulates.

Leather uppers also show limitations in the manufacture of footwear uppers because the leather skin comes in an irregular shape and limited size which cannot be used in a continuous production process. However, alternative synthetic footwear uppers that have been proposed may have reduced durability when compared to leather uppers, and may provide reduced protection against particles and extreme heat.

Accordingly, there is a need for protective textile composites, upper materials comprising the textile composites and footwear comprising the upper materials that provides a good level of protection against heat and flame and particle penetration whilst also providing improved flexibility and reduced weight, and having low water pick up and reduced drying time.

There is also a need for a protective upper material which is not based on natural leather skin and can be used in a continuous footwear manufacture process, in such a way that it is thin enough and pliable enough to be handled easily on footwear lasts.

### SUMMARY

In a first aspect, the present disclosure is directed to a textile composite comprising a) a microfiber based polymeric layer b) an intermediate nonwoven layer, and c) a polymeric barrier layer.

The microfiber based polymeric layer may comprise synthetic polyamide microfibers or polyester microfibers of less than or equal to 1 decitex per fibre and having a diameter of less than 10 μm combined with a polyurethane carrier material.

The textile composite is especially useful for a synthetic upper material and footwear comprising the synthetic upper material. Said textile composite is resistant to ignition as measured by DIN EN 15090, despite using materials a) and b) that on their own, are not ignition resistant according to DIN EN 15090. The textile composites can also be repellent of water from environmental sources such as hose water and weather, and can demonstrate a minimal weight gain by exposure to moisture, and have an effective ability to quickly dry out between uses. Additionally, the present disclosure allows the construction of footwear, especially firefighting footwear, with improved mobility (e.g., relatively thin and lightweight textile composite), with the ability to meet or exceed the non-ignition requirements of DIN EN 15090, with resistance to liquid penetration, durability of performance, and donning and doffing ease.

The microfiber based polymeric layer may be attached to the intermediate nonwoven layer. The intermediate nonwoven layer may be attached to the polymeric barrier layer.

The textile composite may be relatively lightweight. For example, the textile composite may be less than or equal to half of the basis weight per unit area when compared to a standard leather upper.

In some embodiments, the polymeric barrier layer may comprise a fluoropolymer material, a polyurethane material, a polyolefin material or a polyester material. In some embodiments, the polyolefin material may comprise polyethylene or polypropylene.

In some embodiments, the polymeric barrier layer may be a porous membrane or a nonporous membrane.

In some embodiments, the microfiber based polymeric layer may comprise polyamide fibers or polyester fibers. The microfiber based polymeric layer may comprise polyurethane.

In some embodiments, an outer surface of the microfiber based polymeric layer further comprises a surface coating. The surface coating may have a visual structure. The surface coating may be a porous coating. The surface coating may comprise polyurethane. The surface coating may comprise porous polyurethane.

In some embodiments, the microfiber based polymeric layer may comprise one or both of a water repellent treatment and a fire retardant treatment.

In some embodiments, the microfiber based polymeric layer may have a thickness of 0.6 mm to 1.8 mm.

In some embodiments, the microfiber based polymeric layer may have a weight of more than 250 g/m². The microfiber based polymeric layer may have a weight of more than 300 g/m². The microfiber based polymeric layer may have a weight of more than 350 g/m²

In some embodiments, the intermediate nonwoven layer may have a thickness of greater than 0.6 mm. The intermediate nonwoven layer may have a thickness of between 0.6 to 2.0 mm.

In some embodiments, the intermediate nonwoven layer may have a weight greater than 70 g/m². The intermediate nonwoven layer may have a weight of 70 g/m² to 700 g/m².

In some embodiments, the intermediate nonwoven layer may comprise polyester, polyamide, melamine, carbon fiber, oxidized polyacrylonitrile (PAN), or aramides.

In some embodiments, the intermediate nonwoven layer comprises one or both of a water repellent and flame retardant treatment.

In some embodiments, the intermediate nonwoven layer may be a laminate comprising a plurality of layers. The intermediate nonwoven layer may be a 2 layer-laminate. The 2 layer-laminate may comprise the same material or a different material.

In some embodiments, the textile composite may pass the Flame Test according to DIN EN 15025:2017 with the microfiber based polymeric layer forming the flame contacting surface. Accordingly, during the Flame Test the flame applied to the textile composite contacts the microfiber based polymeric layer.

In some embodiments, the microfiber based polymeric layer may be an outer layer comprising a closed outer surface such that particles, for example contaminant particles such as smoke particles, do not substantially penetrate the surface of the microfiber based polymeric layer.

In some embodiments, the textile composite may have a weight of greater than 500 g/m²; of greater than 600 g/m², of greater than 700 g/m², of greater than 800 g/m², or of greater than 900 g/m². The textile composite may have a weight of 500 g/m² to 1500 g/m². The textile composite may have a weight of 600 g/m² to 1500 g/m². The textile composite may have a weight of 700 g/m² to 1500 g/m². The textile composite may have a weight of 800 g/m² to 1500 g/m². The textile composite may have a weight of 900 g/m² to 1500 g/m². The textile composite may have a weight of 500 g/m² to 1000 g/m². The textile composite may have a weight of 500 g/m² to 900 g/m².

In some embodiments, the textile composite may further comprise a protective layer. The protective layer may be attached to the polymeric barrier layer on a side that is opposite to the intermediate nonwoven layer.

In some embodiments, particles may not substantially penetrate the thickness of the textile composite.

In some embodiments, the textile composite may be an outer material for one or more of the following: footwear, gloves, a head covering, a hood, a garment including trousers and jackets, an overall and a combination thereof.

In some embodiments where the textile composite is an upper material for footwear, the microfiber based polymeric layer may be an outer layer of the footwear facing the external surroundings. The footwear may comprise an inner waterproof, water vapour permeable functional lining. The inner waterproof, water vapour permeable functional lining may be in the form of a bootie. The inner waterproof, water vapour permeable functional lining may be a removable bootie. Accordingly, the bootie can be removed from the footwear. For example, the bootie may be removed from the footwear after use to allow separate cleaning of the bootie and the textile composite of the footwear. The bootie may comprise seams that are formed during the manufacture process. The seams may be sealed. The seams may be sealed with a sealing element. For example, the sealing element may be a sealing tape, sealing adhesive, or other sealant.

Typically, the upper forms a sealed surface of the footwear to prevent ingress of particulates and other contaminants into the footwear. In embodiments comprising a bootie, the bootie and upper may prevent ingress of particulates and contaminants to thereby contact the foot of a wearer during use.

The present disclosure also allows the construction of protective garments including footwear such as firefighting footwear which provides the same quality in low heat stress for the wearer relative to conventional leather footwear, and provides low resistance to evaporative transport. In particular, the layers of the construction may provide a resistance to evaporative transport, as measured by Ret, of less than 50 m² Pa/W, or of less than 25 m² Pa/W.

In some embodiments, the microfiber based polymeric layer may comprise a textile structure comprised of microfibers or bundles of microfibers, or combinations thereof, wherein the microfibers or bundles of microfibers are at least partially surrounded by a polymeric carrier material, for example a microporous or a foamed polymeric carrier layer. In some embodiments, the textile structure can be entangled or interwoven microfibers or bundles of microfibers that further comprises a polymeric carrier material which at least partially impregnates the microfiber textile structure. In other embodiments, the textile structure can be a sheet of randomly oriented or non-randomly oriented microfibers or bundles of microfibers that further comprises a polymeric carrier material that at least partially impregnates the microfiber textile structure. In one embodiment, the microfiber textile structure is completely embedded in the polymeric carrier material.

The polymeric carrier material may comprise a polymer that at least partially surrounds or penetrates the microfibers or bundles of microfibers, or a polymer that penetrates at least a portion of the voids between the microfibers. The microfiber based polymeric layer may comprise microfibers or bundles of microfibers embedded within the polymeric carrier material.

In some embodiments, the polymeric carrier material may comprise a polymer resin, for example, a polyurethane, a polyester, a polyether or a copolymer or a blend thereof. In still further embodiments, the polymer carrier material is microporous polymer or is a polymer foam. In some embodiments, the polymeric resin comprises polyurethane material. In other embodiments, the polymeric carrier material can be a microporous polyurethane or a polyurethane foam. In alternative embodiments, the microfiber based polymeric layer is partially embedded in the polymeric carrier material, for example, a foamed polymeric carrier material.

The microfiber based polymeric layer may further comprise a coating. In some embodiments the microfiber based polymeric layer comprises at least one surface coating made of the polymeric carrier material. The coating may seal the surface of the microfiber based polymeric layer and optionally may be embossed to provide a textured surface to the microfiber based polymeric layer. Accordingly, the microfiber based polymeric layer may have a sealed surface that can help to limit the ingress of particles into or across the microfiber based polymeric layer. In some embodiments the surface coating comprises a polyurethane. The surface coating may be treated to create a specific surface structure like a leather appearance.

The relatively thin textile composite (thickness less than 3.5 mm, for example) for footwear upper of the disclosure has been found to be substantially equally fire resistant and to be substantially equally resistant to particles and thermal radiation, as well as flexible when compared to standard leather footwear uppers of a given thickness. The textile composite may have insulating properties.

The textile composite also comprises an intermediate nonwoven layer attached to the microfiber based polymeric layer and improves durability and flame resistance of the textile composite. The intermediate nonwoven layer may have insulating properties.

The intermediate nonwoven layer may provide support, strength, thermal insulation or a combination thereof to the microfiber based polymeric layer. In embodiments, the intermediate nonwoven layer may be a reinforcing and a strengthening layer. The intermediate nonwoven layer may provide thermal insulation to an upper material to reduce the transport of heat across the upper material. As a result, the textile composite comprising the intermediate nonwoven layer may provide thermal insulation to thereby reduce transport of heat across the textile composite. For example, in footwear comprising the textile composite, the intermediate nonwoven layer may reduce the transfer of heat from outside of the footwear into the interior of the footwear. Accordingly, the foot of a user within the footwear may be at least partially protected from extreme heat.

The textile composite further comprises a polymeric barrier layer. In preferred embodiments, the polymeric barrier layer may comprise a fluoropolymer. The polymeric barrier layer may comprise polytetrafluoroethylene (PTFE). The polymeric barrier layer may comprise a porous polymer. The polymeric barrier layer may comprise a porous fluoropolymer. For example, the polymeric barrier layer may comprise an expanded fluoropolymer such as expanded PTFE (ePTFE). In some embodiments, the polymeric barrier layer may comprise a porous polymer, for example, a fluoropolymer, a polyurethane, a polyolefin, a polyester, a polyimide, silicon containing polymer or a copolymer or a combination thereof.

In some embodiments, the polymeric barrier layer may be combined with other materials to create separable components containing composite layers which are separable from other layers within the footwear upper or within a garment. These separable components are generally not bonded to one another across the majority of their surfaces, although they may be attached together at edges, perimeters or at discrete points, for example at seams. In alternative embodiments, the separable components may be removably attached with other components of the garment through the use of, for example, hook and loop fasteners, buttons, snaps or a combination thereof. As one example, the textile composite may comprise the outermost layer of a jacket that is removably attached to an inner lining through the use of one or more snaps or buttons.

The textile composite disclosed herein may have a thickness of in the range of 0.6 mm to 3.5 mm. The textile composite may have a thickness of in the range of 1.0 mm to 3.5 mm. The textile composite may have a thickness of in the range of 1.2 mm to 3.5 mm.

The textile composite may be compressed after assembly. Accordingly, the textile composite may have a thickness that is less than the sum of the thickness of each layer in the textile composite prior to compression.

The textile composite disclosed herein may have a weight of in the range of 550 g/m² to 1300 g/m².

In any of the above embodiments the textile composite disclosed herein is typically flame resistant according to DIN EN 15025:2017.

In any of the above embodiments the textile composite disclosed herein is water vapour permeable according to the Moisture Vapor Transmission Rate (MVTR) test as explained below.

According to a second aspect there is provided footwear comprising the textile composite of the first aspect wherein the footwear upper of the footwear comprises the textile composite. The term “footwear upper” means that the textile composite is used, at least partially, as the outermost material for forming a footwear upper wherein the microfiber based polymeric layer is forming the exterior surface of the footwear upper and the polymeric barrier layer is forming an interior surface of the footwear upper.

According to a third aspect there is provided a garment comprising the textile composite of the first aspect, wherein the microfiber based polymeric layer is forming, at least partially, an exterior garment surface and the polymeric barrier layer is forming, at least partially, an interior garment surface.

The garment may be selected from the group comprising jackets, trousers, gloves, hoods, head coverings and overalls.

The footwear upper may comprise an outer textile layer. The outer textile layer may comprise natural or synthetic fibres comprising flame resistant cotton, modacryl blends, polyester, polyamide, high tenacity polyester or mixtures thereof. The textile may comprise a flame retardant fibre comprising aramide fibres such as those provided under the trade names NOMEX® aramid fibre, KEVLAR® aramid fibre or KERMEL® aramid fibre; leather or rubber. The textiles may be woven or knitted.

According to a fourth aspect, there is provided footwear comprising a footwear upper and a removable bootie, the footwear upper comprising a textile layer. The removeable bootie may be removed from the footwear after use to allow separate cleaning of the bootie and the textile composite of the footwear. The bootie may comprise seams that are formed during the manufacture process. The seams may be sealed. The seams may be sealed with a sealing element. For example, the sealing element may be a sealing tape, sealing adhesive, or other sealant.

The removeable bootie may comprise an inner waterproof, water vapour permeable functional lining. The water vapour permeable functional lining may be provided on the inside of the removeable bootie. The removeable bootie may further comprise a textile supporting layer. The removable bootie may comprise a liquid resistant membrane.

### BRIEF DESCRIPTION OF THE FIGURES

Embodiments of the present invention will now be described, by way of non-limiting example, with reference to the accompanying drawings.

FIG. 1 is a schematic cross section of a footwear upper according to embodiments of the present disclosure;

FIG. 2 is a schematic cross section of a footwear upper according to embodiments of the present disclosure;

FIG. 3 is a schematic figure of a footwear;

FIG. 4 is a schematic figure of a footwear upper;

FIG. 5 is a schematic figure of a footwear upper,

FIG. 6 is an SEM of a cross section of a polyamide microfiber/polyurethane matrix, and

FIG. 7 is a schematic cross-section of a shoe comprising a footwear upper, a sole and a bootie.

### DETAILED DESCRIPTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

As used herein, the term “liquid water resistant membrane” refers to a layer comprising a membrane or film which has a minimum liquid water resistance as measured by a Suter Hydrostatic Pressure Tester of greater than 0.5 psi. In some embodiments the liquid water resistant membrane has a liquid water resistance as measured by a Suter Hydrostatic Pressure Tester of greater than 4 psi, alternatively greater than 10 psi, and alternatively greater than 20 psi.

The present disclosure relates to a textile composite comprising a) a microfiber based polymeric layer, attached to b) an intermediate nonwoven layer; attached to c) a polymeric barrier layer. The microfiber based polymeric layer, when used as a part of a garment, for example, a footwear upper, constitutes the outermost layer of the garment. As part of a garment and/or a footwear upper, the polymeric barrier layer is a layer that is closer to the wearer than the microfiber based polymeric layer and the intermediate nonwoven layer is in between the microfiber based polymeric layer and the polymeric barrier layer.

The term “microfiber based polymeric layer” means a microfiber textile layer made substantially of a very fine synthetic microfiber/yarn which is combined with a polymer carrier material. The microfibers can be individual microfibers, they can be bundles of microfibers or a combination of both individual and bundles of microfibers. The microfibers can vary in length from a few millimeters to essentially endless in the case of microfiber filaments and the microfibers can be laid down in almost any pattern, for example, in a random pattern, a non-random pattern or in textile form. Typically, several layers of microfibers are placed one on top of the other to form a layer of microfibers, and to provide a thickness to the microfiber based polymeric layer. The layer of microfibers can then be coated with the polymeric carrier material, and the polymeric carrier material optionally foamed, in order to make the microfiber based polymeric layer. The polymeric carrier material can be a polyurethane, a polyester, a polyether or a copolymer or a combination thereof. In some embodiments, the polymer resin can be a polyurethane resin, a foamed polyurethane resin or a microporous polyurethane resin. The coating of the microfibers can be performed by any of the known coating process, for example, transfer coating, dip coating, knife coating, spray coating, hot melt coating, extrusion coating or roller coating. In some embodiments, the microfiber textile layer is submerged in a solution of the polymeric carrier material, for example, a polyurethane resin. The mixture of the microfiber textile layer and the polymer solution can be coagulated to remove the solvent and to form a microporous polymeric carrier. In other embodiments, the polymeric carrier material coating the microfibers can be foamed to introduce pores into the polymeric carrier material. In other embodiments, the composite of microfiber textile layer and a polyurethane resin may comprise a thin top coat of the polyurethane resin applied to one or both surfaces of the microfiber textile layer. The thin top coat of the polyurethane resin may be mechanically treated to form a textured surface to the microfiber based polymeric layer. In still further embodiments, the polymeric carrier material may be water vapor permeable (breathable).

The term “microfiber” refers to a very fine synthetic fiber/yarn of less than or equal to 1 (one) decitex/fiber and having a diameter of less than 10 micrometers. Suitable microfibers can be made from polyester, polyamides (e.g. nylon, TROGAMID® polyamides, available from Evonik, Essen, Germany), or a combination of polyester and polyamide microfibers.

The microfiber based polymeric layer may comprise microfibers, bundles of microfibers, or combinations thereof. The microfibers can be in the form of a textile, wherein the microfibers are woven, knit, nonwoven or a combination thereof. In some embodiments, the microfiber based polymeric layer may comprise polyamide fibers. The polyamide fibers may comprise aliphatic polyamides, such as nylon.

In some embodiments the microfiber based polymeric layer may have a thickness of 1.8 millimeters (mm) or less. In some embodiments, the microfiber based polymeric layer may have a thickness of 1.6 mm, 1.4 mm, 1.3 mm, 1.2 mm, 1.1 mm or 1.0 mm or less. The microfiber based polymeric layer may have a thickness of 0.9 mm or less. The microfiber based polymeric layer may have a thickness of from about 0.6 mm to 1.8 mm. The microfiber based polymeric layer may have a thickness of from about 0.6 mm to 1.3 mm. For example, the microfiber based polymeric layer may have a thickness of about 0.6, 0.7, 0.8, 0.9, 1.0, 1.1, 1.2, 1.3, 1.4 or 1.5 mm or values therebetween.

The microfiber based polymeric layer may have a weight of 250 grams per square meter (g/m²) or greater. The microfiber based polymeric layer may have a weight of greater than 300 g/m². The microfiber based polymeric layer may have a weight of greater than 350 g/m². The microfiber based polymeric layer may have a weight of greater than 400 g/m². The microfiber based polymeric layer may have weight of greater than 450 g/m². In still further embodiments, the microfiber based polymeric layer may have a weight of from 250 g/m² to 1000 g/m². The microfiber based polymeric layer may have a weight of from 300 g/m² to 1000 g/m². The microfiber based polymeric layer may have a weight of from 300 g/m² to 750 g/m². The microfiber based polymeric layer may have a weight of from 300 g/m² to 500 g/m². The microfiber based polymeric layer may have a weight of from 350 g/m² to 450 g/m².

The microfiber based polymeric layer may be a flammable layer. The microfiber based polymeric layer may not pass the ignition requirements of DIN EN 15090. In order to improve the ignition resistance of the microfiber based polymeric layer and/or to provide other beneficial properties, the microfiber based polymeric layer may be treated. For example, the treatment may provide water repellant properties, and/or may provide ignition resistant properties to the microfiber based polymeric layer. The microfiber based polymeric layer may further comprise one or both of a water repellent coating and an ignition resistant coating. Suitable water repellent coatings may include for example, fluorochemical or fluoropolymer-based coatings, silicon-containing coatings or a combination thereof. The ignition resistant coating may comprise any of the known ignition resistant coatings, containing for example, melamine, phosphates, polyphosphates, melamine-polyphosphate, aluminum hydroxide, magnesium hydroxide, or any of the known organohalo- or organophosphorous coatings or a combination thereof. While treatment with an ignition resistant coating may improve the performance of the microfiber based polymeric layer, it is not expected that the treatment will allow the microfiber based polymeric layer, on its own, to pass the ignition resistance criteria of DIN EN 15090.

The textile composite also comprises an intermediate nonwoven layer that may be attached to the microfiber based polymeric layer. The intermediate nonwoven layer may improve the durability and flame resistance of the textile composite. The term “nonwoven layer” means a sheet or web of bonded or entangled fibers or filaments. The fibers or filaments can be bonded or entangled by mechanical, thermal and/or chemical means as is well known in the art. As used herein, fibers have a relatively short length, typically less than about 20 cm. Preferably, the fibers have a length of less than 1 cm. The term “filaments” means a relatively long fiber, that is, a fiber that has a length to width or diameter ratio of greater than 1000.

In some embodiments, the intermediate nonwoven layer may provide support, strength, thermal insulation or a combination thereof to the microfiber based polymeric layer. In other embodiments, the intermediate nonwoven layer may be a reinforcing and a strengthening layer. In still further embodiments, the intermediate nonwoven layer may provide thermal insulation to the textile composite to reduce the transport of heat across the textile composite. For example, in footwear comprising a footwear upper comprising the textile composite, the intermediate nonwoven layer may reduce the transfer of heat from outside the footwear into the interior of the footwear. Accordingly, the foot of a user within the footwear may be at least partially protected from extreme heat.

The intermediate nonwoven layer may comprise, for example, polyester, polyamide, melamine, carbon fiber, oxidized polyacrylonitrile (PAN), aramides or a combination thereof. In some embodiments, the intermediate nonwoven layer comprises or consists essentially of materials that are not resistant to ignition according to DIN EN 15090, for example, polyamides, polyesters or a combination thereof. Even when using materials that are not resistant to ignition for the intermediate nonwoven layer, the textile composite itself as described herein, can be resistant to ignition according to DIN EN 15090. However, in order to provide certain desired properties to the textile composite, the intermediate nonwoven layer may comprise ignition resistant materials, for example, carbon fiber and/or oxidized polyacrylonitrile. The desired properties of the textile composite can be the combination of ignition resistance with relatively lightweight, softness, flexibility and suppleness.

In some embodiments, the intermediate nonwoven layer may be a laminate comprising a plurality of nonwoven layers. Each layer of the laminate may independently comprise the same material or a different material. One or more of the plurality of layers may comprise polyester, polyamide, or inherently ignition resistant fibers. Inherently ignition resistant fibers may be selected from melamine, carbon fiber, aramides or oxidized polyacrylonitrile (PAN).

In some embodiments, the intermediate nonwoven layer may have a thickness of 0.6 mm to 2.0 mm. The intermediate nonwoven layer may have a thickness of 0.8 mm to 1.5 mm. The intermediate nonwoven layer may have a thickness of 0.6 mm to 1.3 mm. The intermediate nonwoven layer may have a thickness of 0.8 mm to 1.5 mm. The nonwoven layer may have a thickness of greater than 1.0 mm.

The intermediate nonwoven layer may have a weight greater than 70 g/m² to less than or equal to 700 g/m². In some embodiments, the intermediate nonwoven layer may have a weight of greater than 70 g/m². The intermediate nonwoven layer may have a weight of greater than 80 g/m². The intermediate nonwoven insulating layer may have a weight of greater than 100 g/m². The intermediate nonwoven insulating layer may have a weight of greater than 150 g/m². The intermediate nonwoven insulating layer may have a weight of greater than 200 g/m². The intermediate nonwoven insulating layer may have a weight of greater than 350 g/m². In still further embodiments, the nonwoven insulating layer may have a weight of from about 70 g/m² to about 500 g/m². The nonwoven insulating layer may have a weight of from about 70 g/m² to about 475 g/m².

The textile composite also comprises a polymeric barrier layer that is attached to the intermediate nonwoven layer. The polymeric barrier layer is attached to the intermediate nonwoven layer on the side that is opposite the microfiber based polymeric layer. The polymeric barrier layer may be an air permeable membrane or may be a water proof membrane. In other embodiments, the polymeric barrier layer may be an air permeable and water proof membrane. In still further embodiments, the polymeric barrier layer may be waterproof and water vapor permeable. The polymeric barrier layer that is a water proof membrane may allow water vapour to pass through the membrane whilst preventing the passage of liquid water. In some embodiments, the polymeric barrier layer may be a multilayer polymeric barrier layer.

The polymeric barrier layer may comprise a fluoropolymer, a polyurethane, a polyolefin, a polyester, a polyimide, a silicon containing polymer or a copolymer or a combination thereof. In preferred embodiments, the polymeric barrier layer may comprise a fluoropolymer. The polymeric barrier layer may comprise polytetrafluoroethylene (PTFE). The polymeric barrier layer may comprise a porous polymer, for example, an expanded fluoropolymer or expanded PTFE (ePTFE), for example, ePTFE membranes found in U.S. Pat. No. 3,953,566. The polymeric barrier layer in embodiments described herein may comprise a fluoropolymer having a microstructure of nodes interconnected by fibrils, which provide a porous structure. In some embodiments, the microstructure is asymmetric, meaning that the porous structure comprises multiple regions through the thickness of the structures, and at least one region has a microstructure that is different from the microstructure of a second region. Examples of fluoropolymers having a two or more regions of porous structure are provided in U.S. Pat. Nos. 9,944,044 and 9,573,339.

The polymeric barrier layer may optionally comprise a coating, wherein the coating is present on a single side of the polymeric barrier layer. In some embodiments, the coating is present on both sides of the polymeric barrier layer. In still further embodiments, the polymeric barrier layer may be a porous polymeric layer and the coating may be an imbibed coating that at least partially penetrates the pores of the porous polymeric layer. A coating that at least partially penetrates the pores can be a coating that is a coating on the walls that form the pores or the coating may be fill at least a portion of the pores of the porous polymeric barrier layer. The coating may comprise a silicones, moisture vapor permeable polyurethanes or polyesters, or fluoropolymer. In some embodiments, the coating may comprise polyurethane. In some embodiments, the coating is moisture vapour breathable, such as for example an air impermeable moisture vapour breathable polyurethane coating. Other optional coatings include node and fibril fluoropolymer based coatings. In some embodiments, the polymeric barrier layer may include an impregnated monolithic moisture vapour permeable polymer. The coating may be oleophobic. In other embodiments, the polymeric barrier layer may be uncoated.

Examples of materials useful as a polymeric barrier layer include porous and nonporous membranes. The membrane may be air permeable or air impermeable. The membrane may provide breathability as defined as the ability to transport moisture vapour through the membrane. In addition, the membrane may be liquid water resistant to prevent penetration of liquid water. In some embodiments, the polymeric barrier layer may be polytetrafluoroethylene (PTFE), expanded PTFE (ePTFE), another fluoropolymer, polyurethane, polyolefin (e.g. polyethylene, polypropylene), polyimide, polyester, silicone, or a combination thereof.

The textile composite may optionally further comprise a protective layer attached to one side of the polymeric barrier layer, on the side that is opposite the intermediate nonwoven layer. In some embodiments, one surface of the polymeric barrier layer may be laminated to the protective layer. The protective layer may be any material that can provide support and/or durability to a polymeric barrier layer. For example, the protective layer may be a protective polymer coating or a, for example, knit, woven or nonwoven, or a fleece. In other examples, the protective layer may be protective polymer coating in the form of a plurality of lines, a grid, a monolithic coating, etc. Suitable protective polymer coatings can be, for example, polyamides, polyurethanes, polyesters, polyolefins or a combination thereof. In other embodiments, the protective layer may be formed from natural fibres (e.g. cotton, wool), synthetic fibres, for example, rayon, LYCRA® spandex, melamine, cram id, polyamide, polyester, polybenzimidazole (PBI), modacryl or blends thereof. In some embodiments, the protective layer can be a knit, a woven or a nonwoven that is laminated to the polymeric barrier layer.

In embodiments the polymeric barrier layer can be laminated to a protective layer forming a two layer laminate. The two layer laminate may have a thickness in the range of 0.2 mm to 0.5 mm and a weight in the range of 40 g/m² to 150 g/m².

The textile composite may inhibit particulates having a diameter that is greater than or equal to 0.027 micrometers, from penetrating through the textile composite. In other embodiments, the textile composite can inhibit penetration of particles having an average diameter of greater than or equal to 0.03 micrometers, or greater than or equal to 0.04 micrometers, or greater than or equal to 0.05 micrometers, or greater than or equal to 0.06 micrometers, or greater than or equal to 0.08 micrometers, or greater than or equal to 0.09 micrometers, or greater than or equal to 0.1 micrometers. These particulates may otherwise penetrate into the interior of the footwear and expose the wearer to the particulates. While the textile composite can inhibit the penetration of certain sizes of particles through the thickness of the textile composite, particles may contact the interior of a garment comprising the textile composite and ultimately contact the wearer via other means, for example, over the top of a shoe or in through the opening of a sleeve or the head or neck of a jacket.

The disclosed textile composite can be used in a variety of applications, for example, any body-covering garment including, footwear, gloves, jackets, shorts, pants, trousers, coveralls, smocks, aprons, head coverings, hoods, gaiters or a combination thereof. In some embodiments, the textile composite can be used as an outer material in a garment. In some embodiments, the textile composite can be used as a footwear upper material in a shoe or a boot. The term “outer material” is used to describe a material forming at least in parts the outermost layer of a garment including footwear.

The textile composite may be used in combination with one or more additional layers. However, if one or more additional layers are used, the textile composite as disclosed herein is generally used as the outermost layer due to the flame resistant properties that the textile composite can impart to the footwear or garment.

The one or more additional layers may include one or more textile layers, one or more flame resistant (FR) layers, one or more additional membrane layers, one or more foam layers, one or more metal grid or metal foil layers, or combinations thereof. In embodiments where the one or more additional layers comprise a textile, the textile may comprise fibres. The fibres may comprise natural fibres, synthetic fibres or a combination thereof. The fibres may comprise, for example, aramid, polyamide (PA), polysulfone, polyester, polyolefin, polyurethane, polyacrylate, cotton, wool, or mixtures thereof. The textile may be woven, nonwoven, or knit. In embodiments where one or more of the one or more additional layers comprise a foam, the foam may comprise polyethylene (PE), polyvinylchloride (PVC), polyurethane (PU), thermoplastic polyurethane (TPU), ethylene vinyl acetate (EVA), or rubber. In embodiments where the one or more additional layers comprise a metal grid or metal foil, the metal grid may comprise a reflective aluminium grid and the metal foil may comprise an aluminium foil or aluminium breathable foil.

In embodiments where the one or more additional layers comprises a foam layer, the foam layer may be located on the inside of the textile composite during use. For example, when the textile composite is used as a footwear upper or as part of a footwear upper, the foam layer may be located on the inside of the footwear upper.

Each of the one or more additional layers may be up to 6 mm thick. Each of the one or more additional layers may be from 2 mm to 5 mm thick. In embodiments where the textile composite is used in combination with the one or more additional layers, the thickness of the one or more additional layers may be from 1 mm to 6 mm thick. The thickness of the one or more additional layers may be from 2 mm to 5 mm thick. The one or more additional layers may comprise at least 1 layer, at least 2 layers, at least 3 layers or at least 4 layers. The one or more additional layers may comprise 2 layers, 3 layers, 4 layers or 5 layers. If two or more additional layers are present, each of the additional layers can be selected independently of one another.

The one or more additional layer may be in contact with the textile composite. The one or more additional layer may be adhered to the textile composite. The one or more additional layer may be adhered to the textile composite with an adhesive. The one or more additional layer may in contact with the textile composite such that air gaps between the one or more additional layer and the textile composite are prevented.

The one or more additional layers may comprise particulates embedded within them or on the surface of the one or more additional layers. The particulates may be reflective particles, or retro-reflective particles. The one or more additional layers comprising particulates may be located on the outside of the textile composite.

The one or more additional layers may be attached to the textile composite by any conventional means, including sewing, gluing, casting, welding, printing or injecting.

In embodiments where the one or more additional layers are positioned on the outside of the garment, the one or more additional layers may extend over substantially the entirety of the textile composite. The one or more additional layers may extend over only a portion of the textile composite. For example, the one or more additional layers may be resistant to abrasion and may extend over a portion of the textile composite that is vulnerable to abrasion during use.

In embodiments where the textile composite forms a footwear upper, the one or more additional layers may extend over at least part of a toe portion of the footwear upper. The one or more additional layers may extend over at least a part of a heel portion of the footwear upper. The one or more additional layers may extend around the portion where the footwear upper meets the sole of the footwear.

The one or more additional layers may be fire-resistant. The one or more additional layers may be reflective. The one or more additional layers may provide additional support to the foot or ankle of a user during use.

The one or more additional layers may form a continuous surface over the at least portion of the footwear upper over which the one or more additional layers extends. The one or more additional layers may form a discontinuous surface over the at least portion of the footwear upper over which the one or more additional layers extends. For example, the one or more additional layers may be provided as a pattern on the surface of the footwear upper over which the one or more additional layers extends. The pattern may comprise pattern elements. The pattern elements may comprise a grid or a plurality of grids, strips or a series of dots. The pattern elements may comprise a logo, design element or other image element. The pattern may comprise a combination of a different pattern elements.

The one or more additional layers may extend away from the surface of the footwear upper. At least a portion of the covering layer may extend away from the surface of the footwear upper.

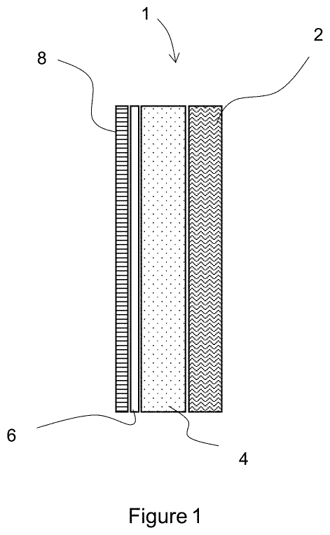

With reference to FIG. 1, there is provided a textile composite 1 comprising a microfiber based polymeric layer 2, an intermediate nonwoven layer 4, a polymeric barrier layer 6 and a protective layer 8. The microfiber based polymeric layer 2 comprises polyamide fibers penetrated by a polyurethane resin. The intermediate nonwoven layer 4 comprises a nonwoven polyester material. The polymeric barrier layer 6 comprises expanded polytetrafluoroethylene. The protective layer 8 comprises a knit material made of polyamide.

The microfiber based polymeric layer 2 is laminated to the intermediate nonwoven layer 4 using a polyurethane adhesive applied in a dot pattern or as a powder (not shown) across the inner surface of the microfiber based synthetic leather layer 2. The protective layer 8 is laminated to the polymeric barrier layer 6 using a polyurethane adhesive applied to the protective layer 8 in a dotted pattern or as a powder (not shown). The laminate of polymeric barrier layer 6 and protective layer 8 are laminated to the laminate of microfiber based polymeric layer 2 and intermediate nonwoven layer 4 using a polyurethane adhesive applied in a dotted pattern or as a powder adhesive (not shown) across the intermediate nonwoven side of the microfiber based polymeric layer/intermediate layer laminate to produce the textile composite 1.

While the textile composite can be constructed by laminating two 2-layer laminates together (as discussed above), other sequential construction techniques could also be used, if desired. For example, a microfiber based polymeric layer can be laminated to the intermediate nonwoven layer, followed by lamination to the barrier layer, and optionally laminated to a protective layer. Any suitable lamination technique could be used wherein the adhesive is applied in a continuous manner across the surface of one layer, the other layer or both layers. In alternative embodiments, the adhesive can be applied in a discontinuous manner across the surface of one layer, the other layer or both layers. Discontinuous applications of adhesives can include, for example, dots, lines, grids or a combination thereof. In some embodiments, the adhesive can include FR additives.

The outer surface of the microfiber based polymeric layer of the textile composite 1 may simulate the appearance of leather and can be used as footwear upper. In other embodiments, the outer surface of the microfiber based polymeric layer may present any other non-leather like appearance. The outer surface of the microfiber based polymeric layer of the textile composite further comprises a sealed surface that prevents the ingress of particulates. Accordingly, footwear comprising the textile composite 1 as footwear upper protects the foot of the wearer from particulates during use. The sealed surface also reduces the uptake of liquids.

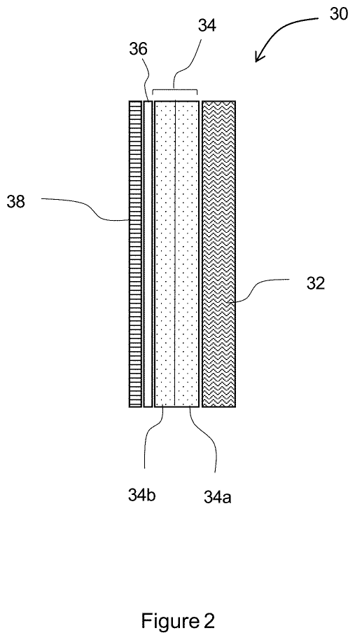

In a further embodiment with reference to FIG. 2 a textile composite 30 comprises a microfiber based polymeric layer 32, an intermediate nonwoven layer 34, a polymeric barrier layer 36 and a protective layer 38. The microfiber based polymeric layer 32 comprises polyamide fibers penetrated by a polyurethane resin. The intermediate nonwoven layer 34 comprises two layers 34a, 34b of a nonwoven oxidized polyacrylonitrile material laminated together.

In alternative embodiments (not shown), the intermediate nonwoven layer comprises one layer of a nonwoven oxidized polyacrylonitrile material laminated to one layer of a polyester material.

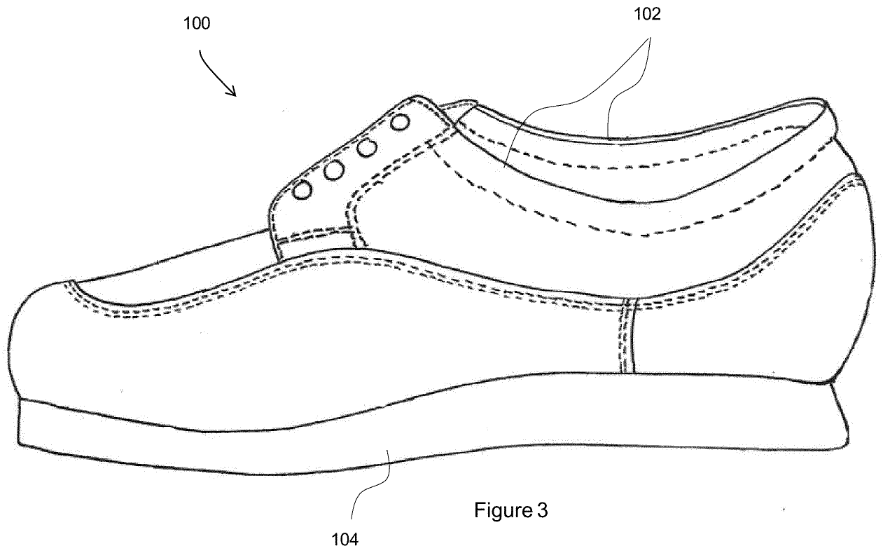

FIG. 3 shows a footwear 100 comprising an outer material 102 and a sole 104. The outer material 102 comprises at least in parts the textile composite of the present disclosure with the microfiber based polymeric layer forming the outermost surface.

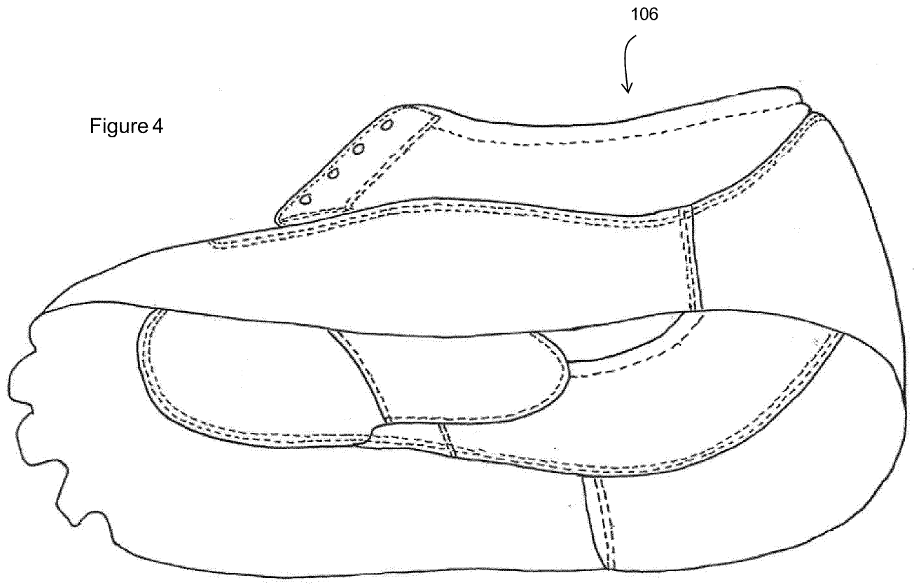

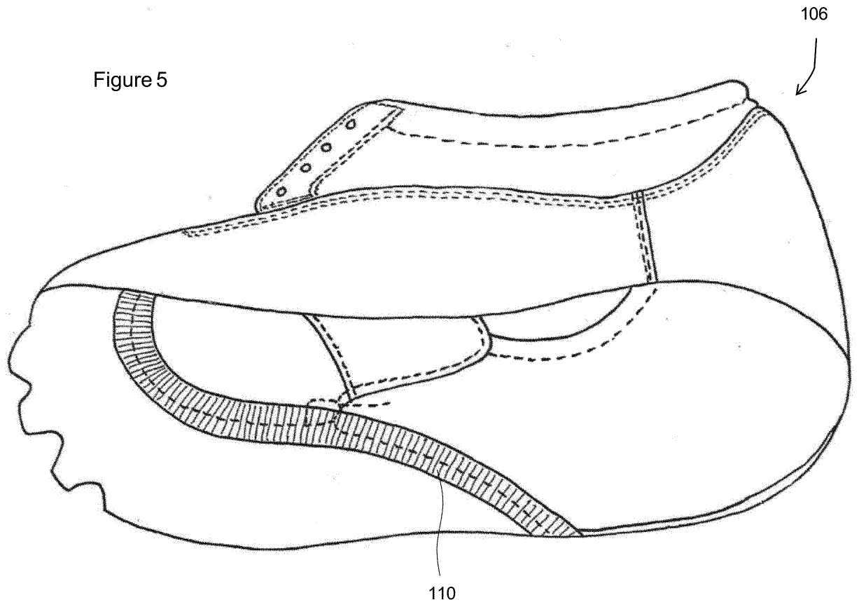

FIG. 4 shows a footwear upper construction 106 in an intermediate stage before closing the upper construction and attaching the sole. The upper construction 106 is manufactured by attaching shaped upper material parts together to build the upper construction 106. The upper material parts can be attached by gluing, sewing, welding or any other know technique. With the use of the textile composite of this disclosure the seams can be waterproof sealed on the inner side of the upper construction using waterproof seam tape 110 as shown in FIG. 5.

The textile composite can be seam sealed to prevent water from penetrating any seams that are used to join two or more pieces of the textile composite together in a garment, for example, a footwear upper. Therefore, the upper material construction using textile composite material can be made waterproof and no external water can enter the inside of the shoe, providing for a low water pick-up shoe construction and allowing the shoe to dry quickly. This provides an added benefit for the disclosed textile composites when compared to leather uppers as leather uppers are too thick to allow the adhesive of a sealing tape to penetrate through the entire thickness and as a result are not able to be seam sealed in order to prevent water ingress. In some embodiments, the textile composite can be waterproof seam sealed on the inner side of the composite. Textile composites as described herein are capable of meeting the non-ignition requirements of DIN EN 15090 despite being made from a microfiber based polymeric layer and an intermediate nonwoven layer that, on their own, are not able to pass the same test. The textile composites can also provide relatively light weight materials that are able to pass the requirements of DIN EN 15090, especially when compared to a natural leather upper of the same weight. In some embodiments, the textile composite can have as low as one-half the weight of a leather upper yet still pass the requirements of DIN EN 15090. Using such thin, light weight material also has the advantage that the upper is able to pick up less liquid/water/moisture than a leather upper.

Footwear 100 may also comprise an inner waterproof, water vapour permeable functional lining on the inner side facing, e.g. in the form of a bootie and as a 2- or 3-layer laminate with a liquid resistant membrane.

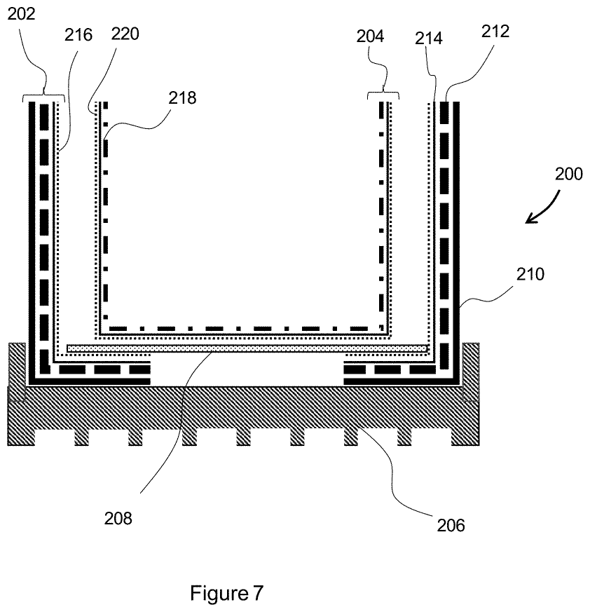

FIG. 7 shows a cross-section of a footwear 200 comprising an upper 202, a bootie 204, an outsole 206 and a lasting board 208. The upper 202 comprises a microfiber based polymeric layer 210, an intermediate nonwoven layer 212, a polymeric barrier layer 214 and a knit backing layer 216. The bootie 204 comprises a waterproof breathable lining 218 and a knit layer 220.

The upper 202 is fixed to the lasting board using a suitable adhesive such as polyurethane, polyamide or neoprene, for example. The upper 202 is also fixed to the outsole 206 using a suitable adhesive. The upper 202 forms a sealed surface to prevent the ingress of particulate contaminants from entering the footwear 200. The bootie 204 may be fixed permanently to the upper 202 and/or the lasting board or else be fixed removably to the lasting board 208 or the upper 202 Accordingly, after use, the bootie may be removed from the footwear to allow the bootie to be cleaned independently of the upper 202, outsole 206 and lasting board 208. Therefore, a first cleaning operation can be used to clean the bootie 204 and a second cleaning operation can be used to clean the upper 202, outsole 206 and lasting board 208. For example, the bootie 204 may be cleaned in a washing machine, or using waterless cleaning methods such as dry cleaning, washing cryogenic solvents or similar. The upper may be cleaned or decontaminated using high pressure water or washing with detergents.

The bootie 204 comprises a seam that are formed during manufacture. The bootie further comprises one or more sealing tapes that run along the seam to thereby seal the inside of the bootie 204 against the ingress of liquid or particulates through the seam into the interior of the bootie 202.

Test Methods

Moisture Vapor Transmission Rate (MVTR)

A description of the test employed to measure moisture vapor transmission rate (MVTR) is given below. The procedure has been found to be suitable for testing films, coatings, and coated products.

In the procedure, approximately 70 ml of a solution consisting of 35 parts by weight of potassium acetate and 15 parts by weight of distilled water was placed into a 133 ml polypropylene cup, having an inside diameter of 6.5 cm at its mouth. An expanded polytetrafluoroethylene (PTFE) membrane having a minimum MVTR of approximately 85,000 g/m²/24 hrs, as tested by the method described in U.S. Pat. No. 4,862,730 (to Crosby), was heat sealed to the lip of the cup to create a taut, leakproof, microporous barrier containing the solution.

A similar expanded PTFE membrane was mounted to the surface of a water bath. The water bath assembly was controlled at 23° C. plus or minus 0.2° C., utilizing a temperature controlled room and a water circulating bath.

The sample to be tested was allowed to condition at a temperature of 23° C. and a relative humidity of 50% prior to performing the test procedure. Samples were placed so the microporous polymeric membrane was in contact with the expanded polytetrafluoroethylene membrane mounted to the surface of the water bath and allowed to equilibrate for at least 15 minutes prior to the introduction of the cup assembly.

The cup assembly was weighed to the nearest 1/1000g and was placed in an inverted manner onto the center of the test sample.

Water transport was provided by the driving force between the water in the water bath and the saturated salt solution providing water flux by diffusion in that direction. The sample was tested for 15 minutes and the cup assembly was then removed, weighed again within 1/1000g.

The MVTR of the sample was calculated from the weight gain of the cup assembly and was expressed in grams of water per square meter of sample surface area per 24 hours.

Resistance to Evaporation of a Textile—Ret Measurement

A means to evaluate the resistance of a material or material set to the transmission of moisture vapor, thus assessing the moisture vapor permeability. Ret is conducted per ISO 11092, 1993 edition, and is expressed in m² Pa/W. Higher Ret values indicate lower moisture vapor permeability.

Suter Hydrostatic Pressure Tester

The sample was clamped in an in-line filter holder (Pall, 47 mm, part number 1235). On the one side of the sample membrane was a liquid that is able to be pressurized. On the other side of the sample membrane, which is open to atmospheric pressure, a piece of colored paper was placed between the sample membrane and a support (perforated plexiglass disk). The sample was then pressurized in 17 kPa increments, waiting 60 seconds after each pressure increase. The pressure that a color change in the paper occurs was recorded as the entry pressure. The liquid used was a 30% IPA-70% water (vol-vol), which results in a liquid surface tension of about 31 dynes/cm (+/−about 1) determined by pendant drop method. Two samples are measured and averaged to provide the initial liquid entry pressure (EPᵢₙᵢₜᵢₐₗ).

Flame Test

Flame testing was performed using DIN EN 15025:2017 with several changes. The first change was that the samples tested were swatches of the textile composites rather than full fire boots as called for in the test method. The second deviation was the angle of the flame. DIN EN 15090 calls fora 45° flame angle, relative to the sample being tested. The individual samples tested in this case were oriented vertically, with the burner oriented horizontally. Finally, the flame height and distance as required by DIN EN 15090 was used. For each textile composite, the flame was directed towards the microfiber based polymeric layer and the side comprising the barrier layer was oriented away from the flame.

The sample evaluation after flame impingement was as follows:

Step one: Is there afterglow or a flame visible up to 10 seconds after removal of the flame impingement?:
Yes—no pass
No—go to step two

Step two: If the sample shows no flame or afterglow look for hole formation:
Yes (hole)—no pass
No hole-pass

For each textile composite tested, at least 6 replicates were used. If any one of the replicates did not pass the test, then the textile composite was said to have failed the test. If each of the replicates passes the test procedure, then the textile composite is said to have passed the test.

Description of Materials Used in the Examples:

Microfiber (MF) Based Polymeric Layers:

MF1: LambSkin 0,8 polyamide microfiber/polyurethane matrix is available from Vela Technologies s.r.l., Vicenza, Italy. The thickness of MF1 is 0.8 mm and it has a weight of 310 g/m². The layer is treated with a non-halogenated flame resistant and with a standard water resistant composition.

MF2: LambSkin 1,0 polyamide microfiber/polyurethane matrix is available from Vela Technologies s.r.l., Vicenza, Italy. The thickness of MF2 is 1 mm and it has a weight of 430 g/m². The layer is treated with a non-halogenated flame resistant and with a standard water resistant composition.

MF3: LambSkin polyamide microfiber/polyurethane matrix is available from Vela Technologies s.r.l., Vicenza, Italy. The thickness of MF3 is 0.78 mm and it has a weight of 310 g/m². The layer is only treated with a standard water resistant composition.

MF4: PigSkin polyamide microfiber/polyurethane matrix is available from Vela Technologies s.r.l., Vicenza, Italy. The thickness of MF4 is 0.87 mm and it has a weight of 266 g/m². The layer is treated with a non-halogenated flame resistant and with a standard water resistant composition.

MF5: Microsuede polyamide microfiber/polyurethane matrix is available from Vela Technologies s.r.l., Vicenza, Italy. The material has same base as MF1, but velour surface optics. The thickness of MF5 is 0.9 mm and it has a weight of 309 g/m². The layer is treated with a non-halogenated flame resistant and with a standard water resistant composition.

MF6: Moron on Steam 2031-Negro polyamide microfiber/polyurethane matrix is available from Grupo Moron Antonio Moron de Blas SL, Arnedo, Spain. The thickness of MF6 is 0.9 mm and it has a weight of 345 g/m². The layer is only treated with a standard water resistant composition.

MF7: Moron on Steam 2031-Negro doble hidrofugato polyamide microfiber/polyurethane matrix is available from Grupo Moron Antonio Moron de Blas SL, Arnedo, Spain. The thickness of MF6 is 0.91 mm and it has a weight of 360 g/m². The layer is treated with a non-halogenated flame resistant and with a standard water resistant composition.

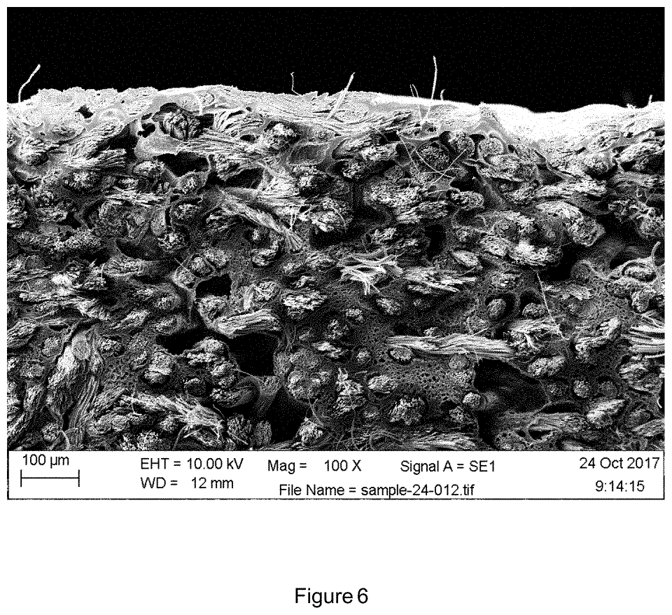

A scanned electron microscope (SEM) image of a cross section of a suitable LambSkin polyamide microfiber/polyurethane matrix is shown in FIG. 6 and illustrates the fineness of the fibers within the matrix.

Intermediate Nonwoven Materials:

Nonwoven 1 is Velastiff KS Extraflex 350 polyester felt and is available from Vela Technologies s.r.l., Vicenza, Italy. The nonwoven 1 has a thickness of 1 mm and a weight of 330 g/m².

Nonwoven 2 is TNT Panox 80 Black Panox felt is available from Vela Technologies s.r.l., Vicenza, Italy. The nonwoven 2 has a thickness of 1.0 mm and a weight of 80 g/m².

Nonwoven 3 is Velaflex KK 550 polyester felt and is available from Vela Technologies s.r.l., Vicenza, Italy. The nonwoven 3 has a thickness of 2.70 mm and a weight of 525 g/m².

Polymeric Barrier Layer:

In the examples below an ePTFE membrane was used (available from W.L. Gore & Associates, Inc, USA). Said porous membrane is an oleophobic polyurethane (PU) coated ePTFE membrane. Furthermore, the membrane comprises a protective textile layer in the form of a polyamide 6.6 knit. The membrane has a thickness of 43 microns and an area weight of 31 g/m².

Table 1 shows the weight (in grams per square meter and the thicknesses of each of the fabric materials used in the examples.

TABLE 1

| Material | Weight [g/m²] | Thickness [mm] |
|---|---|---|
| MF 1 | 315 | 0.78 |
| MF 2 | 430 | 1.02 |
| MF 3 | 310 | 0.78 |
| MF 4 | 266 | 0.87 |
| MF 5 | 309 | 0.90 |
| MF 6 | 345 | 0.90 |
| MF 7 | 360 | 0.91 |
| Nonwoven 1 | 330 | 1.0 |
| Nonwoven 2 | 80 | 1.0 |
| Nonwoven 3 | 525 | 2.70 |

### Example 1

MF 1 was laminated to nonwoven 1 using a copolyamide based adhesive (“Velamelt Copa FR” available from Vela Technologies s.r.l., Vicenza, Italy) to produce a 2-layer laminate.

The 2-layer laminate was then laminated to the ePTFE membrane laminate as described above (available from W.L. Gore & Associates, Inc) on the nonwoven side of the 2-layer laminate using a polyurethane hot melt powder adhesive. The resulting laminate was stored at room temperature for 2 days. Prior to any testing procedure, the laminate was conditioned for 24 hours at 23° C. and 50% relative humidity.

The resulting composite had a thickness of 2.0 mm and a weight of 866 g/m² and has an MVTR of 1430 g/m²/24 hrs.

### Example 2

The laminate of example 2 was produced in the same way as example 1 except that nonwoven 2 was used in place of nonwoven 1.

The ePTFE membrane as described in example 1 and above was placed on the nonwoven side of the 2-layer laminate, using a polyurethane hot melt powder adhesive. The resulting laminate was stored at room temperature for 2 days. Prior to any testing procedure, the laminate was conditioned for 24 hours at 23° C. and 50% relative humidity.

The resulting composite had a thickness of 1.8 mm and a weight of 554 g/m² and has an MVTR of 2030 g/m²/24 hrs.

### Example 3

MF 2 was laminated to nonwoven 1 using a polyamide based adhesive (“Velamelt Copa FR” available from Vela Technologies s.r.l., Vicenza, Italy) to produce a 2-layer laminate.

The 2-layer laminate composite was then laminated to an ePTFE membrane (available from W.L. Gore & Associates, Inc) on the nonwoven side of the 2-layer laminate using a polyurethane hot melt adhesive and a gravure printer with a dot lamination pattern. The resulting laminate was stored at room temperature for 2 days. Prior to any testing procedure, the laminate was conditioned for 24 hours at 23° C. and 50% relative humidity.

The resulting composite had a thickness of 2.33 mm and a weight of 980 g/m² and has an MVTR of 1350 g/m²/24 hrs.

### Example 4

MF 2 was laminated to nonwoven 2 using a copolyamide based adhesive (“Velamelt Copa Fr” available from Vela Technologies s.r.l., Vicenza, Italy) to produce a 2-layer laminate.

The 2-layer laminate composite was then laminated to an ePTFE membrane (available from W.L. Gore & Associates, Inc) on the nonwoven side of the 2-layer laminate using a polyurethane hot melt adhesive and a gravure printer with a dot lamination pattern. The resulting laminate was stored at room temperature for 2 days. Prior to any testing procedure, the laminate was conditioned for 24 hours at 23° C. and 50% relative humidity.

The resulting laminate had a thickness of 1.8 mm and a weight of 670 g/m² and has an MVTR of 1890 g/m²/24 hrs.

### Example 5

MF 3 was laminated to nonwoven 1 using a copolyamide based adhesive (“Velamelt Copa FR” available from Vela Technologies s.r.l., Vicenza, Italy) to produce a 2-layer laminate. The 2-layer laminate was then laminated to the ePTFE membrane laminate as described above (available from W.L. Gore & Associates, Inc) on the nonwoven side of the 2-layer laminate using a polyurethane hot melt powder adhesive. The resulting laminate was stored at room temperature for 2 days. Prior to any testing procedure, the laminate was conditioned for 24 hours at 23° C. and 50% relative humidity.

### Example 6

MF 4 was laminated to nonwoven 3 using a copolyamide based adhesive (“Velamelt Copa FR” available from Vela Technologies s.r.l., Vicenza, Italy) to produce a 2-layer laminate. The 2-layer laminate was then laminated to the ePTFE membrane laminate as described above (available from W.L. Gore & Associates, Inc) on the nonwoven side of the 2-layer laminate using a polyurethane hot melt powder adhesive. The resulting laminate was stored at room temperature for 2 days. Prior to any testing procedure, the laminate was conditioned for 24 hours at 23° C. and 50% relative humidity.

### Example 7

MF 5 was laminated to nonwoven 1 using a copolyamide based adhesive (“Velamelt Copa FR” available from Vela Technologies s.r.l., Vicenza, Italy) to produce a 2-layer laminate. The 2-layer laminate was then laminated to the ePTFE membrane laminate as described above (available from W.L. Gore & Associates, Inc) on the nonwoven side of the 2-layer laminate using a polyurethane hot melt powder adhesive. The resulting laminate was stored at room temperature for 2 days. Prior to any testing procedure, the laminate was conditioned for 24 hours at 23° C. and 50% relative humidity.

### Example 8

MF 5 was laminated to nonwoven 2 using a copolyamide based adhesive (“Velamelt Copa FR” available from Vela Technologies s.r.l., Vicenza, Italy) to produce a 2-layer laminate. The 2-layer laminate was then laminated to the ePTFE membrane laminate as described above (available from W.L. Gore & Associates, Inc) on the nonwoven side of the 2-layer laminate using a polyurethane hot melt powder adhesive. The resulting laminate was stored at room temperature for 2 days. Prior to any testing procedure, the laminate was conditioned for 24 hours at 23° C. and 50% relative humidity.

### Example 9

MF 6 was laminated to nonwoven 1 using a copolyamide based adhesive (“Velamelt Copa FR” available from Vela Technologies s.r.l., Vicenza, Italy) to produce a 2-layer laminate. The 2-layer laminate was then laminated to the ePTFE membrane laminate as described above (available from W.L. Gore & Associates, Inc) on the nonwoven side of the 2-layer laminate using a polyurethane hot melt powder adhesive. The resulting laminate was stored at room temperature for 2 days. Prior to any testing procedure, the laminate was conditioned for 24 hours at 23° C. and 50% relative humidity.

### Example 10

MF 6 was laminated to nonwoven 2 using a copolyamide based adhesive (“Velamelt Copa FR” available from Vela Technologies s.r.l., Vicenza, Italy) to produce a 2-layer laminate. The 2-layer laminate was then laminated to the ePTFE membrane laminate as described above (available from W.L. Gore & Associates, Inc) on the nonwoven side of the 2-layer laminate using a polyurethane hot melt powder adhesive. The resulting laminate was stored at room temperature for 2 days. Prior to any testing procedure, the laminate was conditioned for 24 hours at 23° C. and 50% relative humidity.

### Example 11

MF 7 was laminated to nonwoven 1 using a copolyamide based adhesive (“Velamelt Copa FR” available from Vela Technologies s.r.l., Vicenza, Italy) to produce a 2-layer laminate. The 2-layer laminate was then laminated to the ePTFE membrane laminate as described above (available from W.L. Gore & Associates, Inc) on the nonwoven side of the 2-layer laminate using a polyurethane hot melt powder adhesive. The resulting laminate was stored at room temperature for 2 days. Prior to any testing procedure, the laminate was conditioned for 24 hours at 23° C. and 50% relative humidity.

### Example 12

MF 7 was laminated to nonwoven 2 using a copolyamide based adhesive (“Velamelt Copa FR” available from Vela Technologies s.r.l., Vicenza, Italy) to produce a 2-layer laminate. The 2-layer laminate was then laminated to the ePTFE membrane laminate as described above (available from W.L. Gore & Associates, Inc) on the nonwoven side of the 2-layer laminate using a polyurethane hot melt powder adhesive. The resulting laminate was stored at room temperature for 2 days. Prior to any testing procedure, the laminate was conditioned for 24 hours at 23° C. and 50% relative humidity.

### Comparative Example

A leather material commercially available as footwear upper material from the company HAIX has a thickness of about 2.5 mm and a weight of 1595 g/m². The leather material is treated on skin surface side with a leather finish to improve water resistance. The leather has an MVTR of 3800 g/m²/24 hrs.

When tested according to the Flame Test (procedure given above), the results are provided in Table 2 below:

TABLE 2

| | | Thickness | MVTR | |
|---|---|---|---|---|
| Laminate | Weight (g/m²) | (mm) | (g/m²/24 hrs) | Flame Test |
| 1 | 866 | 2.0 | 1430 | Pass |
| 2 | 554 | 1.6 | 2030 | Pass |
| 3 | 980 | 2.33 | 1350 | Pass |
| 4 | 670 | 1.84 | 1890 | Pass |
| 5 | 820 | 1.97 | 1820 | Pass |
| 6 | 1061 | 3.60 | 3070 | Pass |
| 7 | 915 | 2.20 | 1450 | Pass |
| 8 | 690 | 1.78 | 1380 | Pass |
| 9 | 902 | 2.15 | 2330 | Pass |
| 10 | 590 | 1.70 | 1450 | Pass |
| 11 | 921 | 2.15 | 1310 | Pass |
| 12 | 622 | 1.75 | 1360 | Pass |
| Comp. | 1595 | 2.5 | 3800 | Pass |

As can be seen, all laminates of the examples 1-12 passed the flame test.

Accordingly, it has been surprisingly shown that footwear uppers according to the present disclosure are able to provide flame protection sufficient to pass the flame test standard without requiring increase of weight or thickness of the upper. Therefore, footwear comprising the footwear uppers of the present disclosure provide good flame protection with reduced weight and thickness of material compared to other known footwear, resulting in more flexible, flame protective footwear.

All documents referred to herein are incorporated by reference in their entirety. While there has been hereinbefore described approved embodiments of the present invention, it will be readily apparent that many and various changes and modifications in form, design, structure and arrangement of parts may be made for other embodiments without departing from the disclosure and it will be understood that all such changes and modifications are contemplated as embodiments for other heat exchangers and heat exchanger systems as a part of the present disclosure as defined in the appended claims.

1. A textile composite comprising:
a) a microfiber based polymeric layer;
b) an intermediate nonwoven layer,
c) a polymeric barrier layer,
wherein the microfiber based polymeric layer comprises synthetic polyamide microfibers of less than or equal to 1 decitex per fibre and having a diameter of less than 10 μm combined with a polyurethane carrier material.

2. The textile composite of claim 1, wherein the polymeric barrier layer comprises a fluoropolymer material, a polyurethane material, polyolefin material or a polyester material, or wherein the polymeric barrier layer comprises an expanded polytetrafluoroethylene membrane or an expanded polyethylene membrane.

3. The textile composite of claim 2, wherein the polyolefin material comprises polyethylene or polypropylene.

4. The textile composite of claim 1, wherein the polymeric barrier layer is a porous membrane or a nonporous membrane.

5.-6. (canceled)

7. The textile composite of claim 1, wherein the microfiber based polymeric layer comprises porous polyurethane.

8. The textile composite of claim 1, wherein an outer surface of the microfiber based polymeric layer further comprises a surface coating having a visual structure, optionally wherein the surface coating comprises porous polyurethane.

9. (canceled)

10. The textile composite of claim 1, wherein the microfiber based polymeric layer comprises one or both of a water repellent and flame retardant treatment, and/or wherein the microfiber based polymeric layer has a thickness of 0.6 mm to 1.8 mm.

11. (canceled)

12. The textile composite of claim 1, wherein the microfiber based polymeric layer has a weight of more than 250 g/m², of more than 300 g/m², of more than 350 g/m².

13. The textile composite of claim 1, wherein the intermediate nonwoven layer has a thickness of greater than 0.6 mm, optionally wherein the intermediate nonwoven layer has a weight greater than 70 g/m2, optionally wherein the intermediate nonwoven layer comprise polyester, polyamide, melamine, carbon fiber, oxidized polyacrylonitrile (PAN), or cram ids, optionally wherein the intermediate nonwoven layer comprises one or both of a water repellent and flame retardant treatment.

14.-16. (canceled)

17. The textile composite of claim 1, wherein the intermediate nonwoven layer is a laminate comprising a plurality of layers, optionally wherein the intermediate nonwoven layer of a 2 layer-laminate comprises the same material or a different material.

18. (canceled)

19. The textile composite of claim 1, wherein the composite has a weight of greater than 500 g/m²; of greater than 600 g/m², of greater than 700 g/m², of greater than 800 g/m², of greater than 900 g/m².

20. The textile composite of claim 1, wherein the composite has a weight of less than or equal to 1500 g/m².

21. The textile composite of claim 1, wherein the composite passes the Flame Test according to DIN EN 15025:2017 with the microfiber based polymeric layer forming the flame contacting surface.

22. The textile composite of claim 1, wherein the microfiber based polymeric layer is an outer layer comprising a closed outer surface such that particles do not substantially penetrate the surface of the microfiber based polymeric layer, optionally wherein particles do not substantially penetrate the thickness of the composite.

23. (canceled)

24. The textile composite of claim 1, wherein the textile composite further comprises a protective layer, wherein the protective layer is attached to the polymeric barrier layer on a side opposite the intermediate nonwoven layer.

25. The textile composite of claim 1 is an outer material for any of the following: footwear, gloves, a hood, a head covering, a garment including trousers and jackets, an overall and combinations thereof.

26. Footwear comprising the textile composite according to claim 1, wherein the microfiber based polymeric layer is an outer layer facing the external surroundings.

27. The footwear of claim 26, comprising an inner waterproof, water vapour permeable functional lining, optionally wherein the inner waterproof, water vapour permeable functional lining is a removable bootie.

28. (canceled)
